(19) United States
(12) Patent Application Publication
(10) Pub. No.: US 2022/0162718 A1
(43) Pub. Date: May 26, 2022

(54) Method For The Production Of Metal Products Starting From Ferrous Material, By Means Of An Electric Arc Furnace

(71) Applicant: I.BLU S.R.L., Pasian di Prato (IT)

(72) Inventors: Paolo Gosparini, Fagagna (IT); Mirko Bottolo, San Vito al Tagliamento (IT); Elia Gosparini, Fagagna (IT)

(21) Appl. No.: 17/440,833

(22) PCT Filed: Mar. 19, 2020
(86) PCT No.: PCT/IT2020/050064

§ 371 Date: Sep. 20, 2021

(30) Foreign Application Priority Data
Mar. 20, 2019 (IT) 102019000004029
May 13, 2019 (IT) 102019000006770

(51) Int. Cl. C21C 5/52

(52) U.S. Cl. CPC C21C 5/527; C21C 2005/5282

(57) ABSTRACT

Method for the production of metal products starting from ferrous material, by means of an electric arc furnace.

### FIELD OF THE INVENTION

Embodiments described here concern a method for the production of metal products starting from ferrous material, by means of an electric arc furnace, and the use of a polymeric material in said method.

### BACKGROUND OF THE INVENTION

Iron and steel methods are known to produce metal products by melting post-consumer ferrous material.

These methods typically provide a thermal cycle which consists of three macro steps:
preheating of the ferrous material;
melting of the ferrous material, in which a molten bath of molten metal material is obtained;
refining of the molten metal material, in which the final molten metal product is obtained.

Upstream and downstream of these steps, there are typically provided respectively the supply of the ferrous material and the casting of the molten metal product.

It is known that the transition of the ferrous material from the solid state to the liquid state occurs at high temperatures, which vary according to the type of ferrous material used, and typically in the order of several hundred, up to thousands, degrees centigrade.

The use of electric arc furnaces is known in these methods, to provide the heat and therefore the thermal energy necessary to bring about this transition.

The electric arc furnaces, for example, comprise a crucible, in which the ferrous material to be melted is loaded, and electrodes, which can be of a variable type, for example of graphite, and can be disposed in a variable manner according to the different configurations of the furnace.

By way of example, the functioning of the electric arc furnaces is based on the ignition of an electric arc between the electrodes inside the crucible, which interacts with the ferrous material by means of different mechanisms.

The electric arc can reach very high temperatures, of the order of thousands of degrees, for example being able to reach even 11000° C., to provide the ferrous material with the thermal energy necessary to take it to the liquid state and redefine its chemical-physical characteristics.

On the basis of the disposition and of the functioning mechanism, different types of electric arc furnaces are known, which for example comprise single-phase furnaces, three-phase furnaces, direct arc furnaces, indirect arc furnaces, resistance arc furnaces.

The use of burners inside the crucible of the electric arc furnace is also known, to trigger combustion processes that provide additional energy and heat to the ferrous material, promoting the phase transition to the liquid state.

In these cases, in the steps of preheating and melting the ferrous material, heat is generated by the combined action of the electric arc and the burners.

Typically, the burners can be configured as lances that directly introduce combined streams of oxygen and fuels into the crucible, such as oil derivatives, coke derivatives, coke dust, hydrogen, natural gas, syngas.

It is also known that a key parameter in these steel processes is the steel grade of the final metal product.

In particular, it is known that in the refining of the molten metal material, the use of carbon sources is provided, suitable to generate a reducing agent able to reduce the iron oxides present in the molten bath of molten metal material.

Typically, the carbon sources can include traditional fossil sources, anthracite, MET-coke, PCI (Pulverized Coal Injected), GPC (Green Petroleum Coke).

By way of example, the carbon sources can react with oxygen generating carbon oxides, including carbon monoxide.

Carbon monoxide can then react with the iron oxides, reducing them and thus obtaining metallic iron.

The reactions can occur in different modes and involve different chemical species based on the conditions in which they occur.

By way of example, in temperature ranges comprised between 900-1100° C., the reduction of FeO to metallic Fe can occur, while at lower temperatures reduction reactions of the iron oxides with high oxidation number (for example Fe3O4 and Fe2O3) can occur, producing iron oxides with a lower oxidation number (for example FeO).

It is known that in some cases and based on requirements, the carbon sources can also be used as fuel in the preheating and melting steps.

A first disadvantage of these methods is therefore that generating the reducing agent, as well as the combustion in the preheating and melting steps, requires the use of derivatives of fossil fuels, with the resulting disadvantages.

For example, although coke is a good fuel, with a calorific value of around 26 MJ/Kg, it has disadvantages related to the costs and environmental impact of the extraction processes and processing plants, such as for example coking plants.

It is also known that often these fossil fuels can contain sulfur or nitrogen compounds which, following combustion, release polluting substances into the atmosphere.

There are also disadvantages if natural gas and/or methane is used as a fuel and/or as a carbon source.

Natural gas, in fact, although characterized by an excellent calorific value, higher than 30 MJ/m³, and by a reduced presence of sulfur-based pollutants, has significant extraction costs and disadvantages connected to its transport.

These disadvantages can be linked, for example, to the availability of gas pipelines and/or the need to liquefy the gas to transport it in LNG carriers and subsequently regasify it.

The use of alternative carbon sources is also known, so that the amount of fossil sources introduced into the process can be reduced. These alternative sources can allow a reduction in the amount of carbon processed, but also have significant disadvantages depending on the type of material used.

For example, from document U.S. Pat. No. 5,322,544, it is known to use ELT (End of Life Tires), shredded tires from which the part made of textile/steel fiber has been removed, as a substitute for charge anthracite and insufflated depending on size. It has a calorific value not unlike that of anthracite and has a lower carbon content in favor of the percentage of hydrogen. However, there are various problems related to the presence of sulfur, since it is vulcanized rubber. This limits the possibilities for using this carbon source given the problem related to the formation of sulfur chemical compounds such as SO₂ or ternary acids such as H₂SO₄.

The use of ASR (Automotive Shredded Residues) as a substitute for fossil sources is also known from document US-A-2019/0046992. The ASR are a fraction of the shredding of the so-called ELV (End of Life Vehicles) after the removal of the recyclable fractions such as air bags, batteries, wheels, belts. It is of variable size, pulverized or briquetted, and can be used to replace anthracite, however this practice has significant disadvantages. In particular, the calorific value is lower than anthracite (15-25 MJ/kg), it has a decidedly high ash content (10-25%), heavy metals and a chemical composition that is not constant with very high variability. Below is an example of the variability of the chemical composition on multiple samples of the same size of ASR:

| | | LIGHT | HEAVY |
|---|---|---|---|
| % | METHOD | FRACTION | FRACTION |
| ASH | CNR IRSA 2 Q | 23 | 12.2 |
| | 64 VOL 2 1984 | | |
| Cl | UNI EN | 1.2 | 1.8 |
| | 15408: 2011 | | |
| S | UNI EN | 0.23 | 0.4 |
| | 15408: 2011 | | |
| H | UNI EN | 6.21 | 9.1 |
| | 15407: 2011 | | |
| N | UNI EN | 1.41 | 4.2 |
| | 15407: 2011 | | |
| C | UNI EN | 47.7 | 58.2 |
| | 15407: 2011 | | |
| VOLATILE | ASTM D5142 | 72 | 84.8 |
| MATTER | | | |

The strong variability of the analyses in question invalidates the performance of the ASR in the steel process, since the inconstant chemical composition does not allow to guarantee constant performances inside the furnace. In particular, some parameters, such as the high presence of ashes, negatively affects the energy efficiency of the melting process, since they increase their specific consumption. Furthermore, the reactions of gasification and volatilization of the ASR are violent and rapid, therefore they do not allow to manage the chemical intake efficiently in the furnace, and take the temperature profiles of the fumes/panels to reach peaks caused by the amount of thermal energy not absorbed by the bath/scrap. In addition, the percentage of chlorine is uncontrolled, since there is currently no known technique for accurately selecting each element present in the ASR, and since each shredded scrap is different depending on the vehicle and the typical interior upholstery. In addition, the non-constant and/or controlled presence of chlorine limits the use of ASR given the criticality linked to the formation of dioxins/salts/hydrochloric acid in the steel production cycle. These effects compromise its benefits as a substitute source of traditional fossil sources and imply, compared to coke, the need to increase the energy input to the bath through natural gas and oxygen, increasing traditional consumption. The use of HDPE, possibly mixed with MET-coke, is also known from document V. Sahajwalla et al., “Recycling Waste Plastics in EAF Steelmaking: Carbon/Slag Interactions of HDPE-Coke Blends”, Steel Research International, Verlag Stahleisen Gmbh, Dusseldorf, DE, vol. 80, no. 8, 1 Aug. 2009. This solution has the disadvantage that HDPE has between 27% and 30% of residual ash. Consequently, although the use of HDPE can bring benefits to the foaming of the slag, the practice is limited by the low calorific value and by the high amount of combustion residue (ash), which increase, also in this case, the energy consumption of the furnace.

Document CN-A-106350635 describes the combined use of ELT and generic plastic waste, pulverized and used in a combined manner, however with the technical/application limit of using 379 kg/basket of generic plastic waste, 406 kg/basket of ELT and 462 kg/basket of coke. The use of this blend is also limited to the sole foaming effect of the slag, due to chemical limits of the ELT-plastic waste blend. In particular, one problem with the use of ELT lies in the percentage of sulfur, even higher than 1% by weight.

US-A-2011/0239822 describes the use, in the production process of ferroalloys, of a carbon source and a polymer containing carbon, the latter comprising one or more types of rubber (synthetic or natural) and other polymers such as PP, PS, polybutadiene styrene and APS, to inflate the slag. The technical limitation deriving from this practice derives from the fact that there are no other additional benefits to the foaming effect, and that it is not possible to replace the coke/anthracite mixture used with more than 60%.

There is therefore the need to perfect the iron and steel processes that use electric arc furnaces and therefore make available a method for the production of metal products starting from ferrous material, by means of an electric arc furnace, which can overcome at least one of the disadvantages of the state of the art.

In particular, one purpose of the present invention is therefore to provide a method that eliminates, or at least reduces, the need to supply materials coming from fossil sources in the iron and steel processes that use electric arc furnaces.

Another purpose of the present invention is also to provide a method which reduces the energy costs associated with the production, processing and combustion of fossil sources.

Another purpose of the present invention is to reduce the costs associated with the supply of fuels and/or carbon sources in the iron and steel processes which use electric arc furnaces.

Another purpose of the present invention is to reduce the environmental impact of iron and steel processes that use electric arc furnaces.

Another purpose of the present invention is to increase the availability of fuels and/or carbon sources suitable to be used in iron and steel processes that use electric arc furnaces.

Another purpose of the present invention is to provide fuels and/or carbon sources which have a controlled chemical composition, with a low fraction of polluting substances, for example based on sulfur and chlorine, reducing the polluting emissions typical of the practices mentioned above.

Another purpose of the present invention is to provide a fuel and/or a carbon source that has characteristics of density and morphology suitable to be introduced into the electric arc furnace by means of burners and/or introduction lances.

Another purpose of the present invention is to provide a polymeric product which can replace, even completely, the traditional carbon source used, for example anthracite.

Another purpose of the present invention is to provide a controlled carbon and hydrogen source with constant characteristics aimed at stabilizing the iron and steel process and overcoming the limits of the current state of the art that derive from the use of alternatives to fossil sources.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, embodiments of the present invention concern a method for the production of metal products starting from ferrous material, by means of an electric arc furnace, comprising:
preheating and melting of the ferrous material by the combined action of the electric arc of the electric arc furnace, and of the combustion of a fuel, in which the ferrous material is transformed into a molten metal material;
refining of the molten metal material, which is transformed into a molten metal product by the action of a reducing agent generated from carbon sources;

wherein a polymeric material is used in at least partial replacement of the fuel for the preheating and the melting and/or the carbon sources for the refining.

The present invention also concerns the use of a polymeric material in a method for the production of metal products starting from ferrous material, by means of an electric arc furnace, comprising:
preheating and melting of the ferrous material by the combined action of the electric arc of the electric arc furnace and of the combustion of a fuel, in which the ferrous material is transformed into a molten metal material;
refining of the molten metal material, which is transformed into a molten metal product by the action of a reducing agent generated from carbon sources;

wherein a polymeric material is used in at least partial replacement of the fuel for the preheating and melting and/or of the carbon sources for the refining.

According to some embodiments, the polymeric material as above derives from waste, from refuse or from recycling, in particular from domestic, urban and/or industrial waste.

According to some embodiments, the polymeric material as above comprises two or more of: Polyethylene (PE), Polypropylene (PP), Polyethylene terephthalate (PET), High Density Polyethylene (HDPE), Low Density Polyethylene (LDPE), or combinations thereof.

According to some embodiments, the polymeric material as above has a calorific value not lower than 30 MJ/Kg, referred to the dry sample after 4 hours of drying at 105° C.

According to some embodiments, the polymeric material as above comprises a polymeric fraction at least greater than 50% by weight on the dry sample.

According to some embodiments, the polymeric material as above has an ash residue at 550° C. lower than 8%, in particular lower than 7%, more in particular lower than 6%, even more in particular lower than 5%, evaluated according to the CNR IRSA 2 Q64 Vol. 2 1984 method, or other equivalent recognized international standard. For example, the ash residue content can be between 2.5% and 8%, in particular between 2.5% and 7%, more in particular between 2.5% and 6%, even more in particular between 2.5% and 5%.

According to some embodiments, the polymeric material as above, comprises a chlorine content not higher than 2%, referred to the dry sample after 4 hours of drying at 105° C.

According to some embodiments, the polymeric material as above comprises a sulfur content not higher than 5000 mg/kg, according to the DIN 51724-3 (2012-07) method, or other equivalent recognized international standard.

The Applicant has therefore developed a polymeric material substantially different from the state of the art, in particular for use in metallurgic furnaces such as an electric arc furnace.

In particular, to obtain the polymeric material used here, a selected flow of polymers, which can for example be formed by two or more of: Polyethylene (PE), Polypropylene (PP), Polyethylene terephthalate (PET), High Density Polyethylene (HDPE), Low Density Polyethylene (LDPE), or combinations thereof, in contents at least greater than 50%, is first subjected to a process of removal of pollutants, such as foreign fractions containing chlorine/heavy metals and polymers such as PVC not suitable for the iron and steel process, for example by the action of optical readers or flotation on air/water. This allows to overcome the technical limitations deriving from the high percentage of sulfur, chlorine and ash. Thanks to the selection of the polymeric matrices described above, it is also possible to radically increase the calorific value, so that it is not lower than 30 MJ/Kg, advantageously even well above 35 MJ/kg. Furthermore, by making the polymeric material by means of selection as described above, the chemical composition thereof is made constant, guaranteeing continuity of the performance of the EAF furnace.

Therefore, by using a selected flow of polymers as advantageously described above to obtain the polymeric material described here, it is possible to advantageously obtain a low percentage of chlorine, sulfur, residue (ash), a high lower calorific value, and a constant chemical composition, with the consequent advantages described here.

Advantageously, in some embodiments the polymeric material used in the embodiments described here is densified, that is, it is subjected to densification. Here, in the present description and in the claims, with the term densification we mean any process of volumetric reduction that can be attributed to agglomeration, conglomeration, extrusion, pelletizing, homogenization and drawing so that products are obtained with a physical form that can be traced back to briquettes, agglomerates, flakes, pellet, conglomerate, densified product. The densification allows to obtain a densified polymeric material which has been homogenized. The densification allows to eliminate the gaseous inclusions, reducing as a consequence the unwanted emission of gaseous substances in the subsequent processing steps in the electric arc furnace, reduce humidity, and increase the density and stratification of the polymeric material. In particular, the result of the densification operation of the polymeric material allows a gradual and controlled volatilization of CO and H₂, so that the polymeric material remains in the EAF furnace for longer, preventing violent gasification in the early stages of the melting cycle. A direct consequence is the gradual release of thermal energy, which can be processed by the EAF and not dissipated on panels/fumes; this allows an increase in the efficiency of the process.

Unlike other practices that provide mixtures of HDPE and coke or ELT, plastics and coke or plastics and ELT, the polymeric material thus densified allows to be able to replace, even completely, the coke/anthracite normally used, therefore with a replacement ratio that can even reach 1:1. In addition, the constant and gradual release of CO—H₂ following the densification allows, in addition to foaming the slag, to obtain two equally important effects: one is the protective effect of the bath, the other is the replacement effect of the ferroalloys. Normally, in fact, in the state of the art the violent release of CO—H₂, and the low permanence in the bath, would not allow the homogeneous protection of the percentages of determinate elements of the steel in the bath during the melting cycle, such as, depending on the type of steel produced, Cr, Fe, Si. This characteristic is typical of non-densified and/or pulverized products used in the state of the art, for which use is limited only to the foaming of the slag, and it is still necessary to use anthracite loaded into the basket and/or injected; for this reason, in the state of the art it is in fact impossible to completely replace the coke. Instead, in the present invention, thanks to the densified physical form, the densified polymeric material remains for a long time and gradually releases CO—H₂ preventing the oxidation of the typical elements to be preserved in the bath, thus achieving the protective effect. Consequently, since it is no longer necessary to deoxidize the elements oxidized in the slag, it is possible to reduce the use of ferroalloys and, therefore, the polymeric material is in fact a substitute for them.

Therefore, the increase in efficiency of the melting process in the arc furnace is made possible, compared to the state of the art, thanks to the use of the polymeric material described here. The differentiation from the state of the art by using the polymeric material described here is summarized as follows:
reduction of the percentage of sulfur and chlorine;
increase in the calorific value;
lowering of the percentage of ashes;
constancy of the chemical composition;
use of the polymeric material in densified form, where the densification ensures gradual volatilization in the bath;
protective effect and replacement effect of ferroalloys;
efficiency of the energy transfer to the scrap;
possibility of complete replacement of the anthracite and of the injection powder normally used, thus being able to reach a replacement ratio of even 1:1.

The Applicant has also found that the use of the polymeric material according to the present invention acts as a stabilizer of the method for the production of metal products starting from ferrous material, by means of an electric arc furnace, in particular noting that some Key Performance Indicators (KPI) of the steel have a reduced variability by using the polymeric material described here.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 shows the result of calorific value analysis of samples of polymeric material in accordance with embodiments of the present invention;

FIG. 2 shows the result of analysis of chlorine content in samples of polymeric material in accordance with embodiments of the present invention;

FIG. 3 shows the result of analysis of sulfur content in samples of polymeric material in accordance with embodiments of the present invention;

FIG. 4 shows by means of a block diagram example embodiments of the method of the present invention.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the phraseology and terminology used here is for the purposes of description only, and cannot be considered as limitative.

Unless otherwise defined, all the technical and scientific terms used here and hereafter have the same meaning as commonly understood by a person with ordinary experience in the field of the art to which the present invention belongs. Even if methods and materials similar or equivalent to those described here can be used in practice and in the trials of the present invention, the methods and materials are described hereafter as an example. In the event of conflict, the present application shall prevail, including its definitions. The materials, methods and examples have a purely illustrative purpose and shall not be understood restrictively.

All the percentages and ratios indicated refer to the weight of the total composition (w/w), unless otherwise indicated.

All percentage ranges shown here are provided with the provision that the sum with respect to the overall composition is 100%, unless otherwise indicated.

All the intervals reported here shall be understood to include the extremes, including those that report an interval “between” two values, unless otherwise indicated.

The present description also includes the intervals that derive from uniting or overlapping two or more intervals described, unless otherwise indicated.

The present description also includes the intervals that can derive from the combination of two or more values taken at different points, unless otherwise indicated.

The Applicant has developed a polymeric material to be used in iron and steel methods which use an electric arc furnace for the production of metal products from ferrous material.

In some embodiments, the polymeric material developed by the Applicant comprises a mixture of heterogeneous plastic materials.

In some embodiments, the heterogeneous plastic materials can derive from waste material, from refuse or from recycling, or derive from virgin material, that is, not from recycling, waste or refuse.

For example, the heterogeneous plastic materials that can be used can comprise waste or recycled plastic materials, for example from domestic, urban and/or industrial refuse, of a heterogeneous type and possibly with a high plastic content.

The waste plastic materials can for example comprise waste or recycling of household material, industrial waste, packaging, disposable plastic objects, plastic refuse in general.

In some embodiments, the heterogeneous plastic materials can also derive from recycling methods of these waste plastic materials.

In particular, by way of a non-limiting example, the waste plastic materials can be collected in special disposal or selection plants, and possibly sent to special recycling plants, equipped to further select the various components of the plastic.

By way of example, a typical separation that occurs in these plants separates reusable waste plastic materials, for example because they lend themselves to be melted again and processed to form new products, and non-reusable waste plastic materials, for example because if subjected to new heat or chemical treatments they can degrade and possibly carbonize.

Plastic materials coming from recycling and suitable for a new use are typically indicated as secondary-raw plastic materials.

Plastic materials, refuse and/or secondary-raw materials, typically comprise a large variety of heterogeneous polymers with variable chemical structures.

In some embodiments, the polymeric material developed by the Applicant therefore comprises plastics and polymers in all their forms, including, by way of a non-limiting example, in the form of raw material, secondary raw material, by-product, refuse, or combinations thereof.

In some embodiments, the polymeric material can comprise at least one thermoplastic polymer, for example a thermoplastic polyolefin, or a mixture of thermoplastic polymers, for example thermoplastic polyolefins.

In some embodiments, the polymeric material can comprise a mixture of polymer-based recycled plastic materials.

In some embodiments, the polymeric material can comprise any plastic polymer whatsoever, for example Polyethylene (PE), Polypropylene (PP), Polyethylene terephthalate (PET), High Density Polyethylene (HDPE), Low Density Polyethylene (LDPE), or combinations thereof, advantageously two or more of the polymers as above, or combinations thereof.

In some embodiments, the polymeric material comprises a binary mixture of Polyethylene (PE) and Polypropylene (PP).

The polymeric material can possibly also comprise, in addition to at least one of these plastic polymers, also one or more elastomers, for example styrene butadiene rubber (SBR) and/or natural rubber (NR).

In some embodiments, the polymeric material of the present invention can therefore include a polymeric fraction, which in some embodiments can be present in a percentage higher than 50%, preferably higher than 65%, even more preferably higher than 80% by weight on the dry sample, and a non-polymeric fraction, in a percentage substantially complementary to the polymeric fraction.

Advantageously, the non-polymeric fraction of the polymeric material can include heterogeneous materials, for example inert materials, or even materials suitable to provide additional characteristics to the polymeric material, so as to guarantee a wide versatility of use for it.

In particular, it can be advantageous to use the polymeric material with a low percentage of polymeric fraction, in any case within the ranges indicated above, in iron and steel operations that require particular characteristics or functionalities, which can be provided by means of the materials included in the non-polymeric fraction.

On the other hand, it can be advantageous to use the polymeric material with a high percentage of polymeric fraction, in any case within the ranges indicated above, in iron and steel operations that require high carbon contents and/or high calorific value.

Here and in this description, when the calorific value is mentioned, we always refer to the so-called lower calorific value (LCV), normally determined by subtracting the latent heat of vaporization of the water formed during combustion from the higher calorific value (HCV).

In fact, in these cases a high content of heterogeneous polymers ensures a high fraction of carbon and hydrogen in the polymeric material.

Thanks to this high fraction of carbon and hydrogen, the polymeric material is suitable to be used as a fuel in combustion reactions, in which the carbon contained in the polymers is converted into, for example, carbon monoxide and/or carbon dioxide.

In some embodiments, high polymeric fractions, containing carbon and hydrogen, can be associated with a high calorific value.

Advantageously, by varying the percentages of polymeric and non-polymeric fraction it is possible to modulate the carbon content and the calorific value of the polymeric material.

In some embodiments, the polymeric material can have a calorific value not lower than 30 MJ/Kg, referred to the dry sample after 4 hours of drying at 105° C., in accordance with regulation UNI EN 15400, or other recognized equivalent international standard.

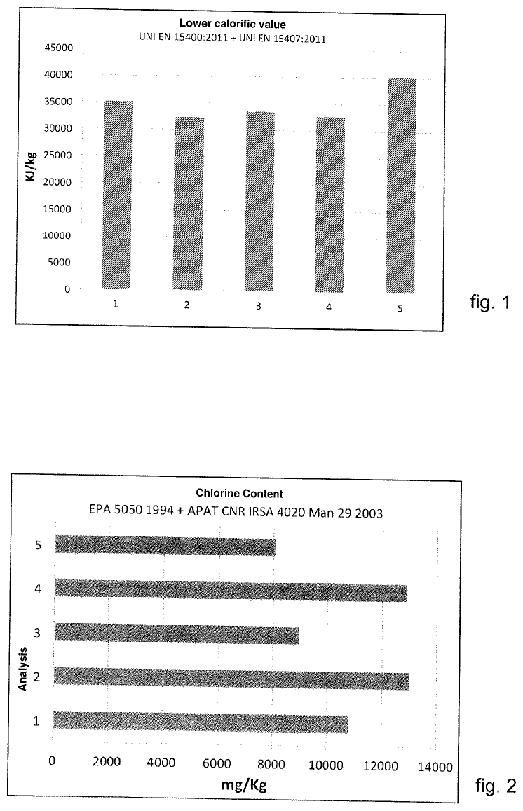

For example, FIG. 1 shows the results of five calorific value analyses performed on five different samples of polymeric material, in which it is possible to observe that the calorific value is always higher than 30 MJ/Kg.

In some embodiments, some substances, potentially unwanted, coming from waste plastic materials and/or from refuse, may also be present in the non-polymeric fraction of the polymeric material.

However, the Applicant has found that these substances, even when present, constitute a minimal and negligible fraction of the polymeric material, and do not exceed the technical standards and legislation in force and applicable for products used in the iron and steel industry.

For example, in some embodiments, the polymeric material can comprise a chlorine content not higher than 2%, referred to the dry sample after 4 hours of drying at 105° C., in accordance with regulation UNI EN 15408, or other recognized equivalent international standard.

FIG. 2 shows the results of various analysis procedures aimed at quantifying the chlorine fraction contained in five samples of polymeric material.

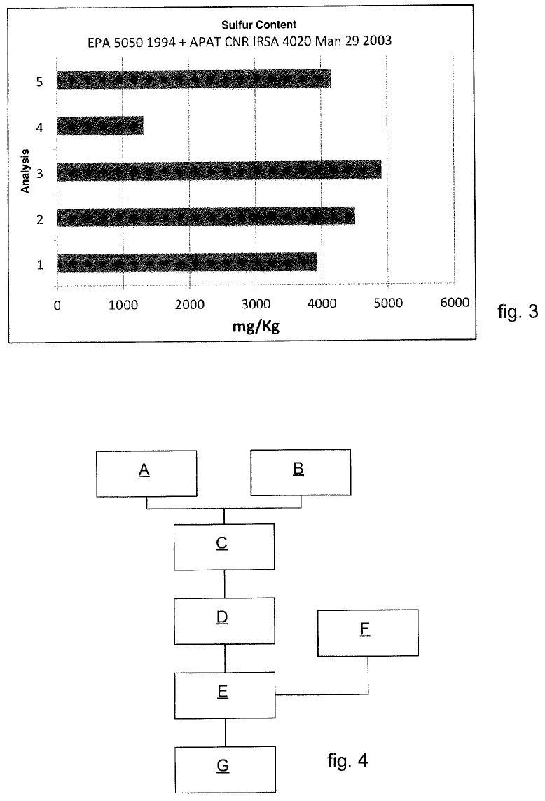

It is possible to observe that, in these examples, the maximum values of chlorine fraction recorded are around 13000 mg/Kg, which corresponds to 1.3% by weight. This value is lower than the 2% limit threshold provided by legislation for the use of materials in iron and steel processes. Furthermore, FIG. 3 shows the results of analyses conducted on five samples of polymeric material for the quantification of the sulfur content.

It is possible to observe how the polymeric material can comprise very small fractions of sulfur, even equal to zero.

For example, bar 4 of FIG. 4 shows sulfur values just above 1000 mg/Kg, which corresponds to about a fifth of the limit value for the sulfur content for iron and steel use.

In general, sulfur fractions of less than 5000 mg/kg were recorded in all cases, which corresponds to the limit value for the sulfur content in materials for iron and steel use.

Therefore, in some embodiments, the polymeric material can comprise a sulfur content not higher than 5000 mg/kg, which corresponds to 0.5% by weight, according to the DIN 51724-3 (2012-07) method, or other equivalent recognized international standard.

In some embodiments, by suitably selecting the polymeric material, so that it advantageously comprises two or more of: Polyethylene (PE), Polypropylene (PP), Polyethylene terephthalate (PET), High Density Polyethylene (HDPE), Low Density Polyethylene (LDPE), or combinations thereof, it is possible to obtain even more advantageous values of calorific value, chlorine content and sulfur content, as summarized in the table below for analyses conducted on five samples of selected polymeric material as described above (the analysis methods used are as above):

| | Analysis | Analysis | Analysis | Analysis | Analysis |
|---|---|---|---|---|---|
| | 1 | 2 | 3 | 4 | 5 |
| Cl % | 0.36 | 0.36 | 0.48 | 0.37 | 0.53 |
| S % | 0.05 | 0.12 | 0.0584 | 0.173 | 0.07 |
| LCV | 43 | 36.1 | 39.1 | 35.41 | 35.68 |
| MJ/Kg | | | | | |

In some embodiments, therefore, it is possible to obtain calorific values higher than 35 MJ/kg.

In other embodiments, it is possible to obtain chlorine content values lower than 1%, advantageously lower than 0.6%.

In other embodiments, it is possible to obtain sulfur content values lower than 1%, advantageously lower than 0.6%.

Furthermore, in some embodiments, the percentage of residual humidity present in the polymeric material of the present invention can be controlled and adjusted if necessary.

Advantageously, it is possible to vary the percentage of residual humidity according to requirements, giving versatility of use to the polymeric material of the present invention.

In some embodiments, the polymeric material can have a residual humidity not higher than 10% by weight, preferably not higher than 2% by weight.

The polymeric material can also be conformed in variable shapes and sizes according to requirements.

For example, in some embodiments it can be shaped as spheres, pellets or granules of variable diameter, or flakes, densified, or even in cylindrical, discoid or elongated shapes.

In some embodiments, the polymeric material can also be finely shredded or pulverized, to be picked up and moved for example by streams of air and/or gas at high pressure or high speed.

For example, in some embodiments the polymeric material can be made as granules with a diameter varying between 0.1 mm and 10 mm, and in other embodiments this range can also be wider, for example between 0.1 mm and 300 mm.

In some embodiments, the polymeric material is densified, that is, it has undergone a densification operation, in which the fragmented material is processed to obtain a densified material, to improve its physical properties.

With the term densification we mean any process of volumetric reduction attributable to agglomeration, conglomeration, extrusion, pelletization, homogenization, drawing and plasticization, or their derivatives, such as “densifier”, “densified”, “plasticizer” or “plasticized”, “conglomerator” or “conglomerate”, and so on. Each of these processes can be understood as “densification”, that is, a process through which the polymer fraction of a primary heterogeneous mixture, or even only part of it, is taken to melting point, so that it is thickened and homogenized, for example due to thermal heating effect and friction effect due to rubbing. Here and in the following description, it will be possible to use equivalently also the term “densification”, or its derivatives, such as “densifier” or “densified”, or the term “agglomeration”, or its derivatives, such as “agglomerate” and “agglomerator” as a replacement for “plasticization” or its derivatives, such as “plasticizer” or “plasticized”.

In some embodiments, the plasticization operation can be carried out using an extruder, possibly a twin-screw extruder.

In some embodiments, this operation can be performed for example by feeding the fragmented polymeric material by means of a hopper into the plasticizer, for example into the extruder, which can work in a variable temperature range, suitable to melt the materials that make up the fragmented material.

After being cooled, the densified polymeric material can be directly cut or sectioned to size at exit from the plasticizer, for example by means of shears, to obtain densified material of variable shapes and sizes, as a function of an exit section of the plasticizer and the cutting cadence.

In some embodiments, after the cooling, the densified polymeric material can be subjected to fragmentation in a special fragmentation device. For example, the fragmentation can be a grinding, which can typically be carried out by means of a mill.

The densified polymeric material can then be fragmented into the desired sizes, to obtain a polymeric material in the desired fragmented form, for example in the form of granules, grains, particles or similar fragmented forms, hereafter referred to as granules for simplicity.

In some embodiments, the granules of densified polymeric material can have sizes comprised between 0.01 mm and 300 mm.

In possible implementations, the granules of densified polymeric material can have sizes comprised between 0.01 mm and 3 mm.

In other possible implementations, the granules of polymeric product can have sizes comprised between 3 mm and 10 mm.

In still other possible implementations, the granules of polymeric product can have sizes comprised between 10 mm and 300 mm.

In some embodiments, the densified and fragmented polymeric material can be subjected to screening so as to obtain a polymeric material with uniform sizes.

On the basis of the characteristics of the polymeric material in accordance with the embodiments described here, the Applicant has used the polymeric material of the present invention in a method for the transformation of ferrous material into a metal product by means of an electric arc furnace.

Embodiments of the method of the present invention are described by means of the block diagram shown in FIG. 4.

The method initially provides the supply of ferrous material A.

The ferrous material can comprise any material whatsoever containing a suitable quantity of metal, suitable to be melted in an electric arc furnace, such as for example scrap metal materials or products, ferrous matrix materials, scrap, in particular ferrous scrap.

The ferrous material can be for example stored in a warehouse or scrap yard, or in a storage warehouse.

The ferrous material is loaded, in known modes, into an electric arc furnace of a steel plant, also in itself known, for the production of a metal product starting from ferrous material by means of an electric arc furnace.

The ferrous material can for example be loaded by a loading apparatus, by means of one or more charge baskets and/or by means of a conveyor line, for example provided with a conveyor belt.

The method can also provide the supply of fuel B and/or polymeric material.

The fuel, in itself known, can comprise natural gas, methane and/or other hydrocarbons, oil derivatives, coke derivatives, coke dust, anthracite in various sizes, hydrogen, methane and/or syngas.

In some embodiments, the polymeric material can be used in at least partial replacement of the fuel.

Advantageously, the characteristics of high calorific value and low ash fraction of the polymeric material allow an advantageous use thereof in addition to, or at least in partial replacement of, the fuel.

By way of example, the gaseous fuel (natural gas) normally used typically varies between 3 Nm³/ton and 6 Nm³/ton of loaded scrap (metal charge in the electric arc furnace), while the solid fuel generally used in the state of the art, for example charge anthracite, coke dust, can vary from 0.2% to 2% of the weight of the loaded scrap. For example, between 0.2% and 1.5% by weight of solid fuel can be introduced, in particular between 0.4 and 1.3%.

Here, in the present description and in the claims, with the expression “replacement ratio” or “replacement ratio by mass” or “replacement ratio by weight” we mean the quantity of generic fuel and/or carbon source that it is possible to remove from the process to produce a metal product, replacing it with the polymeric material described here, correlated to the total amount of solid fuel and/or carbon source normally used. For example, in a process in which the total amount of fuel normally used, for example anthracite, is equal to 1000 kg, and it is possible to remove it entirely and instead use the polymeric material according to the embodiments described here, then the replacement ratio will be 1:1. Otherwise, if only 250 kg can be removed, the replacement ratio will be 0.25. In other words, we therefore mean the ratio between quantity of fossil source removed/quantity of fossil source used previously, where the quantities are typically expressed in kilograms, and by fossil source we mean a generic fuel or carbon source, depending on the case.

In some embodiments, the replacement ratio between generic fuel, for example solid, and polymeric material can be variable, based on the percentage of polymeric fraction present in the polymeric material and on the type of fuel used, its physical form, the kinetics of use and the reactivity in the thermodynamic system in which it is used. For the purposes of the present description, the definition provided hereafter applies to the term “replacement ratio”.

In some embodiments, the mass replacement ratio between generic fuel and polymeric material described here can be comprised between 0.2 and 1, preferably between 0.5 and 0.99.

The modes for introducing the polymeric material into the electric arc furnace can vary, for example on the basis of the type of electric arc furnace used, the sizes of the polymeric material and the generic fuel replaced.

In some embodiments, the polymeric material can be directly introduced into the electric arc furnace together with the ferrous material.

In some embodiments, the polymeric material can be loaded directly into the electric arc furnace by mechanical transport means.

The mechanical transport means can for example comprise conveyor belts, possibly integrated with continuous feed technologies, which feed the polymeric material directly into the arc furnace by means of an aperture made in the crucible.

Other embodiments can provide that the polymeric material is loaded into the basket together with the metallic material.

In these embodiments, the sizes of the polymeric material can be variable, preferably reduced to facilitate mixing.

In some embodiments, the polymeric material can be introduced into the electric arc furnace by means of introduction lances, located, for example, at the base of the crucible.

In these embodiments, the polymeric material can be taken to a suitable size so as to be pneumatically transportable and injectable, for example suitable to be moved by streams of air or gas at high pressure and speed.

Possibly, the polymeric material can be introduced by means of lances which allow to have combined streams of oxygen, polymeric material and/or fuel, for example natural gas and/or other types of fossil fuels.

The method of the present invention therefore provides the preheating C of the ferrous material, aimed at increasing the temperature of the ferrous material, by combustion of the fuel and/or the polymeric material.

During the preheating C, the heat is provided by the electric arc, for example even reaching peaks of 11000° C., and by special burners which burn a combined stream of oxygen, fuel and/or polymeric material, or also by means of preheating fumes.

The provision of heat removes the humidity and the volatile components from the ferrous material.

Advantageously, the use of polymeric material in combustion processes allows to obtain quantities of heat comparable or higher than those obtainable for example from the combustion of natural gas, but with significantly more advantageous production costs, transport costs and availability of usable product, as well as optimized energy performance.

Advantageously, the low fraction of residual humidity contained in the polymeric material promotes, in the preheating process of the ferrous material, the removal of the humidity and of the volatile components.

Advantageously, the low fractions of sulfur and chlorine contained in the polymeric material keep the emission of post-combustion pollutants into the atmosphere, such as sulfur dioxide and/or dioxins, at low levels.

Advantageously, the emissions of sulfur and chlorine-based pollutants into the atmosphere related to the combustion of the polymeric material are lower compared to the emissions relating to fossil fuels, in particular coke, anthracite, and compared to the replacement sources of traditional fuels such as ELT and ASR.

Following the preheating C of the ferrous material, the melting D of the ferrous material is provided, in which a molten bath of molten metal material is formed in the crucible of the electric furnace.

In the melting D, the ferrous material therefore passes from the solid state to the liquid state.

Also in the melting D, as for the preheating C, the heat can be generated by the electric arc of the electric arc furnace and by special burners, which burn combined streams of oxygen, fuel and/or polymeric material.

Operational details related to the melting D and related to the use, to the characteristics and to the modes of use of the polymeric material in this step can therefore be similar to what was described above with regards to the preheating C.

In some embodiments, considering the similarity, the preheating C and the melting D can form a single heating step aimed at melting, in which the polymeric material described here is used.

In some embodiments, the supply of ferrous material A, the supply of fuel B, the preheating C and the melting D can be carried out cyclically.

For example, in the event the ferrous material has a considerable bulk and completely fills the crucible of the electric arc furnace, it is possible to partly melt it to reduce its bulk, and subsequently proceed with a new introduction of ferrous material, directly into the molten bath.

According to the present invention, a refinement E is also provided, in which the molten metal material of the molten bath is transformed into the final metal product.

The refinement E provides to give the steel the desired steel grade by the action of a suitable reducing agent, for example CO and H₂, which can be generated by one or more suitable carbon sources.

In some embodiments, the polymeric material can be used in at least partial replacement of the carbon sources, thanks to its high carbon and hydrogen content.

In embodiments described with FIG. 4, parallel to the refinement E, the supply of carbon sources F and/or of the polymeric material of the present invention is then also provided.

Typical traditional carbon sources can comprise, for example, anthracite, MET-coke, Pulverized Coal Injected (PCI), GPC (Green Petroleum Coke) or other types of fossil carbon sources.

It is obvious that operational details and introduction modes described with reference to the step of supplying fuel B can, in some embodiments, also be used with reference to the step of supplying carbon sources F, and different modes can be used on each occasion, according to specific needs.

In some embodiments, in the step of supplying carbon sources F, the polymeric material is preferably injected below the slag, promoting the reduction of the oxides present. In other embodiments, it is loaded into the basket, together with the ferrous material, and/or directly into the electric arc furnace, by means of the mechanical transport means.

By way of example, the reducing agent is generated by the reaction of the carbon sources and/or the polymeric material with oxygen, under appropriate kinetic and thermodynamic conditions.

Typically, the reducing agent can comprise carbon monoxide and/or hydrogen.

In some embodiments, the carbon monoxide can be generated from carbon dioxide, or from the carbon brought by the carbon source and/or the polymeric material.

By way of example, the Applicant has verified that at least the polymeric fraction of polymeric material, in the working conditions of the electric arc furnace, can undergo reactions from which carbon monoxide and hydrogen are produced.

The carbon monoxide and hydrogen thus produced, then take part in the reduction reaction mechanisms, for example of the iron oxides, from which metallic iron is produced.

Typically, the flows of carbon sources for producing medium carbon steel are between 0.2% and 1.5%, preferably between 0.5% and 1.3%.

In some embodiments, the mass replacement ratio between carbon sources and the polymeric material can vary in a range comprised between 0.1 and 1, for example between 0.1 and 0.99, preferably between 0.5 and 0.75.

Furthermore, in some embodiments, during the refinement E, the streams of gas inside the molten bath, for example of carbon monoxide, allow to reduce the iron oxide content.

This operation, which promotes the generation of CO and H₂, combined with other operations, can lead to the swelling of the slag (foaming practices), necessary for a correct optimization of the process.

The molten metal material present in the molten bath, once the desired composition has been reached, becomes molten metal product.

Subsequently, the unloading, or tapping, G of the molten metal product from the electric arc furnace can take place.

By way of example, the unloading, or tapping, G can be achieved by tilting the crucible of the electric arc furnace, typically made horizontally pivoting, so as to allow the outflow of the molten metal product, for example into a ladle.

The Applicant has further conducted experimental comparison tests in the use, on the one hand, of the polymeric material in accordance with the present description, and on the other hand of ASR (Automotive Shredded Residues) as a substitute for fossil sources in the production of metal products starting from ferrous material, by means of an electric arc furnace.

From the experimental data shown below in the table, the Applicant has surprisingly found that the polymeric material described here advantageously acts as a stabilizer of the production process of metal products starting from ferrous material, by means of an electric arc furnace.

In particular, the Applicant has found that, for the same boundary conditions such as scrap type, electrical and chemical input, at the end of the melting and refining cycle some Key Performance Indicators (KPI) of the steel appear to have, using the polymeric material described here, a reduced variability. Downstream of the analyses carried out on castings carried out with ASR and other castings carried out, by comparison, with the polymeric material described here, the data shown in the following table were obtained for carbon content at tapping (% C) and temperature detected at tapping (° C.).

| | | Using the polymeric |
|---|---|---|
| Parameter | Using ASR | material described here |
| Tapping | 0.07-0.47 | 0.10-0.20 |
| % C | | |
| Tapping | 1540-1620 | 1595-1610 |
| ° C. | | |

Therefore, it is evident that compared to the performance of the process with the use of ASR, the use of the polymeric product reduces the variability of significant KPIs of steel, in particular the parameters of carbon content at tapping (% C) and temperature measured at tapping (° C.). These parameters are fundamental since, in the iron and steel industry, they generally indicate whether the process is efficient or not, consequently a limited or small variability is considered extremely advantageous.

It is clear that modifications and/or additions of steps may be made to the method as described heretofore, without departing from the field and scope of the present invention.

It is also clear that, although the present invention has been described with reference to some specific examples, a person of skill in the art shall certainly be able to achieve many other equivalent forms of method, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. Method for the production of metal products starting from ferrous material, by means of an electric arc furnace, comprising:
preheating and melting of said ferrous material by the combined action of the electric arc of said electric arc furnace, and of the combustion of a fuel, wherein said ferrous material is transformed into a molten metal material;
refining of said molten metal material, which is transformed into a molten metal product by the action of a reducing agent generated from carbon sources;
wherein a polymeric material is used in at least partial replacement of said fuel for said preheating and said melting and/or said carbon sources for said refining,
wherein said polymeric material derives from waste, from refuse or from recycling, in particular from domestic, urban and/or industrial waste, and comprises two or more of: Polyethylene (PE), Polypropylene (PP), Polyethylene terephthalate (PET), High Density Polyethylene (HDPE), Low Density Polyethylene (LDPE), or combinations thereof
wherein said polymeric material has a calorific value not lower than 30 MJ/Kg, referred to the dry sample after 4 hours of drying at 105° C.,
wherein said polymeric material comprises a polymeric fraction greater than 50% by weight on the dry sample.

2. Method as in claim 1, wherein said polymeric material derives from or comprises secondary raw plastic materials.

3. Method as in claim 1, wherein said polymeric material comprises at least one thermoplastic polymer, in particular a thermoplastic polyolefin, or a mixture of thermoplastic polymers, in particular a mixture of thermoplastic polyolefins.

4. Method as in claim 1, wherein said method also comprises a step to supply fuel and a step to supply carbon sources, wherein said polymeric material is supplied in at least partial replacement of said fuel and/or said carbon sources.

5. Method as in claim 4, wherein the supply of carbon sources and/or the supply of fuel provide that said polymeric material is finely shredded or pulverized, in order to be picked up and moved.

6. Method as in claim 4, wherein the supply of carbon sources and/or the supply of fuel provides that said polymeric material is loaded into the electric arc furnace together with the metal material by mechanical transport means.

7. Method as in claim 1, wherein the mass substitution ratio between said carbon sources and said polymeric material is in a range comprised between 0.1 and 1, preferably between 0.1 and 0.99, even more preferably between 0.5 and 0.75.

8. Method as in claim 1, wherein the mass replacement ratio between said fuel and said polymeric material is between 0.2 and 1, preferably between 0.5 and 0.99.

9. Method as in claim 1, wherein said polymeric material comprises a polymeric fraction greater than 65% by weight, preferably higher than 80% by weight.

10. Method as in claim 1, wherein said polymeric material comprises a chlorine content not higher than 2%, referred to the dry sample after 4 hours of drying at 105° C.

11. Method as in claim 1, wherein said polymeric material also comprises one or more elastomers, in particular styrene butadiene rubber and/or natural rubber.

12. Method as in claim 1, wherein said polymeric material comprises a sulfur content not higher than 5000 mg/kg, according to the DIN 51724-3 (2012-07) method.

13. Method as in claim 1, wherein said polymeric material is densified.

14. Method as in claim 1, wherein said polymeric material has an ash residue at 550° C. lower than 8%, evaluated according to the CNR IRSA 2 Q64 Vol. 2 1984 method.

15. Method as in claim 1, wherein preheating and melting of said ferrous material constitute a single operating step of said method.

16. Use of a polymeric material in a method for the production of metal products starting from ferrous material, by means of an electric arc furnace, comprising:
preheating and melting of said ferrous material by the combined action of the electric arc of said electric arc furnace and of the combustion of a fuel, in which said ferrous material is transformed into a molten metal material;
refining of said molten metal material, which is transformed into a molten metal product by the action of a reducing agent generated from carbon sources;
wherein said polymeric material is used in at least partial replacement of said fuel for said preheating and melting and/or of said carbon sources for said refining;
wherein said polymeric material derives from waste, from refuse or from recycling, in particular from domestic, urban and/or industrial waste, and comprises two or more of: Polyethylene (PE), Polypropylene (PP), Polyethylene terephthalate (PET), High Density Polyethylene (HDPE), Low Density Polyethylene (LDPE), or combinations thereof,
wherein said polymeric material has a calorific value not lower than 30 MJ/Kg, referred to the dry sample after 4 hours of drying at 105° C.,
wherein said polymeric material comprises a polymeric fraction greater than 50% by weight on the dry sample.
